(19) United States
(12) Patent Application Publication
(10) Pub. No.: US 2012/0182284 A1
(43) Pub. Date: Jul. 19, 2012

(54) ACTIVE MATRIX FOR DISPLAYS AND METHOD OF FABRICATION

(76) Inventors: Chan-Long Shieh, Paradise Valley, AZ (US); Gang Yu, Santa Barbara, CA (US)

(21) Appl. No.: 13/006,799

(22) Filed: Jan. 14, 2011

(51) Int. Cl. G06F 3/038

(52) U.S. Cl. 345/214

(57) ABSTRACT

An active matrix incorporated in a color display device includes an array of pixels arranged in n rows and m columns, each pixel having x elements including at least a red, a green, and a blue element. A plurality of m data lines, a different one of the plurality of m data lines being coupled one each to each column of pixels and to each element in each pixel in the column of pixels. A plurality of xn scan lines is provided, the xn scan lines being divided into n groups of x scan lines each. A different group of three xn scan lines is coupled to each row of the n rows of pixels and each of the different x scan lines in each group is coupled to a different one of the x elements.

### FIELD OF THE INVENTION

This invention generally relates to display devices incorporating an active matrix and more specifically to improved driver organization.

### BACKGROUND OF THE INVENTION

In color display devices incorporating an active matrix, the display/matrix includes an array of 3-element pixels arranged in n rows of pixels and m columns of pixels. A single scan line is used for each row of pixels and three data lines are used in each column of pixels for the three colors, red, green, and blue. Also, generally m is greater than or equal to n which reduces the scan lines relative to the data lines (i.e. the rectangular display is longer horizontally then vertically). The reason for minimizing the scan lines is due, primarily, to limits resulting from active matrix technology.

Scan drivers, which are relatively simple, can be fabricated, at least partially, directly on the backplane or active matrix. Generally, amorphous silicon (a-Si) technology is used because the active matrix is generally fabricated on transparent panels such as glass or hard plastic. As the size and definition of displays increases, the number of rows (n) and columns (m) of pixels increases. In the prior art active matrices, one scan line is provided for each row of pixels (n scan lines) and three data lines (one for each of the three color elements) are provided for each column of pixels (3m data lines). Each scan line is activated in the time of frame time/n so that the time allowed for each scan line is reduced as the size of the display increases. However, a-Si thin film transistors (TFTs) do not have enough mobility and on/off ratio to support a large number of scan lines and, thus, the number of scan lines must be adjusted to stay within the bounds of a-Si thin film transistor technology.

The limitations placed on the display/matrix technology are a serious problem. Also, data drivers are relatively complex and, therefore, expensive. While data drivers are usually fabricated off the backplane and coupled to the backplane externally, it would be highly desirable to reduce the number of data drivers. There is also a desire to reduce the number of data lines and the contact pads associated with data driver chips in displays with small pixel pitch due to product reliability and manufacturing yield.

In future displays with increased pixel counts and higher frame rates, there is also a general desire to reduce the number of pixels in a given scan line due to RC delay issues over the scan lines.

It would be highly advantageous, therefore, to remedy the foregoing and other deficiencies inherent in the prior art.

Accordingly, it is an object of the present invention to provide a new and improved active matrix for displays.

It is another object of the present invention to provide a new and improved active matrix that is relatively simple and less expensive to manufacture.

It is another object of the present invention to provide a new and improved method of fabricating an active matrix for displays.

### SUMMARY OF THE INVENTION

Briefly, to achieve the desired objects of the instant invention in accordance with a preferred embodiment thereof, provided is an active matrix incorporated in a color display device including an array of pixels arranged in n rows and m columns, each pixel including x elements or sub-pixels. A plurality of m data lines is provided, one each coupled to each column of pixels and to each pixel in the column. A plurality of xn scan lines is provided, a different group of the xn scan lines coupled to each of the n rows of pixels and each of the different groups coupled to a different one of the x elements. Thus, expensive data drivers are reduced to at least one third (in a typical red, green, and blue pixel) of the number generally employed. In yet another type of full-color pixel design, a white color element or sub-pixel is added along with the R, G, and B elements or sub-pixels. In the case of additional elements or sub-pixels additional scan lines are added to the system.

The desired objects of the instant invention are further achieved in accordance with a method of operating an active matrix incorporated in a color display device including the step of providing an array of pixels arranged in n rows and m columns, each pixel having x elements including at least red, green, and blue elements, a plurality of m data lines, one each coupled to each column of pixels and to each pixel in the column, and a plurality of xn scan lines, a different group of the xn scan lines coupled to each of the n rows of pixels and each of the different groups coupled to a different one of the x elements. The method further includes the steps of activating the xn scan lines once for each frame one scan line at a time so as to activate the elements in the array of pixels one element per pixel at a time and activating the m data lines in a sequence to supply at least red, green and blue data in synch with the xn scan lines so as to supply red data to the red elements, green data to the green elements, and blue data to the blue elements as each of the red, green, and blue elements is activated by the scan lines. In yet another type of full-color pixel design, a white color element or sub-pixel is added along with the R, G, and B elements or sub-pixels.

The above described strategy can be expanded to add more sub-pixels with different color primaries, such as complimentary colors to improve the color gamut of the display. In such displays a similar pixel layout and operation mechanism can be used with 4n, 5n, to 7n scan lines.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a simplified diagram of a single pixel in a prior art display and backplane or active matrix;

FIG. 2 is a simplified diagram of a single pixel in an improved active matrix in accordance with the present invention;

FIG. 3 is a schematic diagram of a typical active matrix light generating element driver circuit;

FIG. 4 is a simplified diagram of another format for an active matrix in accordance with the present invention; and

FIG. 5 is a simplified schematic diagram of a portion of the active matrix illustrated in FIG. 3.

### DETAILED DESCRIPTION OF THE DRAWINGS

Throughout this discussion it should be understood that thin film transistors (generally TFTs) are used as an example but that other thin film devices may be included in the definition of TFTs. The figure of merit in TFTs is defined by μV/L² where μ is the mobility, V is the voltage and L is the gate length. A major problem is partially remedied by the recent advance in metal oxide semiconductor materials in which mobility as high as 80 cm²/V-sec has been demonstrated. One of the unique features of metal oxide semiconductors is that carrier mobility is less dependent on grain size of films, that is, high mobility amorphous metal oxide is possible. Throughout this discussion it should be understood that when references are made to active devices in the backplane or active matrix or to scan drivers the active devices are preferably metal oxide TFTs (MOTFT) or poly silicon TFTs. Because of the higher mobility and improved on/off ratio of either MOTFTs or poly-Si TFTs there is little or no constraint on the number of scan lines used in a backplane.

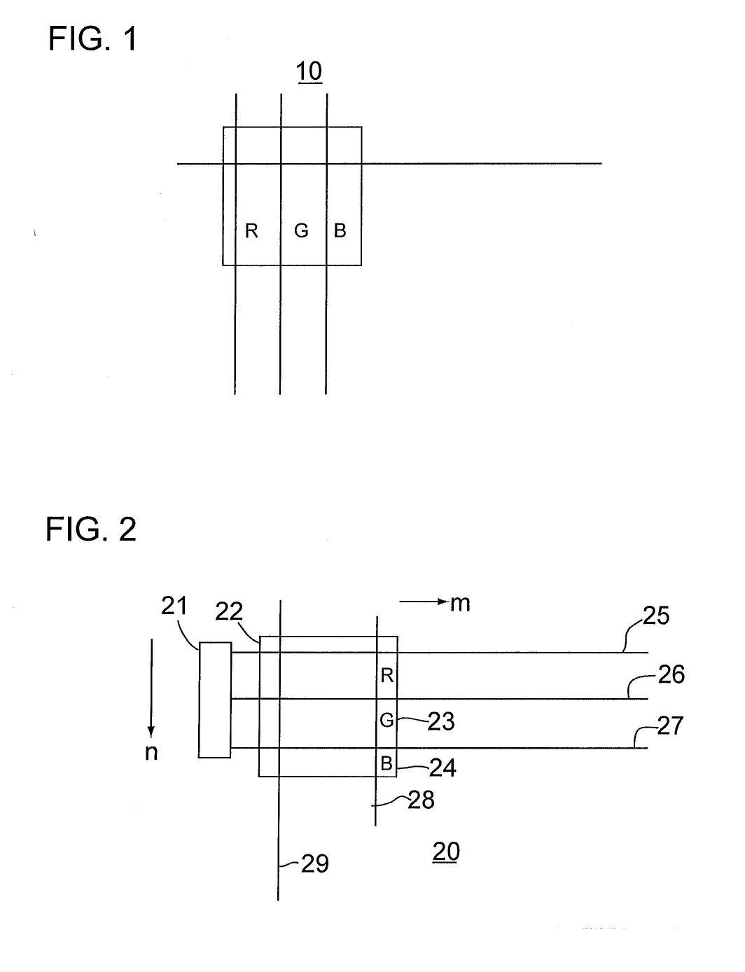

Referring to FIG. 1 a prior art display and active matrix is represented by a simplified diagram of a single pixel 10. As understood in the art for color displays, each pixel of a display includes a red, a green, and a blue light generating element or component. It will be understood, however, that pixels can include additional color elements (e.g. white) to improve the color gamut of the display and the reference to R, G, and B is intended to include any such additional color elements. The present invention generally applies to displays incorporating Organic Light Emitting Devices or OLED displays but could be applied to an array of liquid crystal devices (LCDs) and other types of displays (such as those based on the electrowetting effect, one example is disclosed in U.S. patent application Ser. No. 10/574,448). Pixel 10 includes a red, a green and a blue OLED with a separate data line coupled to each OLED and a single scan line coupled to all three OLEDs of pixel 10. In FIG. 1, each red, green, and blue OLED is generally rectangularly shaped with the long dimension being oriented vertically and the OLEDs positioned side-by-side horizontally so that the overall pixel is substantially square. By orienting the elements or components vertically with a data line and a power line extending through each element, the data and power lines obscure a substantial portion of the illumination (i.e. the fill factor is reduced). Further, as explained above, 3m data lines and 3m data drivers are required. Since the data drivers are substantially more complex and expensive the overall cost of this format is expensive.

Referring now to FIG. 2, a display and active matrix in accordance with the present invention is represented by a simplified diagram of a single pixel 20. It will be understood that single pixel 20 represents an array of pixels arranged in n rows and m columns. Pixel 20 includes a red, a green, and a blue light generating element or component (preferably OLEDs), designated 22, 23, and 24, respectively. Elements 22, 23, and 24 are approximately equal in area, and each element has a generally rectangular configuration with a horizontal length greater than the vertical width. Further, the elements are arranged in a side-by-side orientation vertically to form a column or stack of elements.

In this improved format three scan lines 25, 26, and 27 are coupled, one each, to elements 22, 23, and 24, respectively. Because each pixel can include a number of elements different than three, the scan lines applied to each pixel may be generically referred to herein as ‘xn’, where x represents the number of scan lines or the number of pixel elements. Generally, all of the scan lines are coupled to one or more scan driver circuits, designated 21, that sequentially activate each scan line in a predetermined order and in each frame of display. Scan driver circuit or circuits 21 can be fabricated on the backplane of the active matrix. A single data line 29 is also coupled to each of the three (or more) elements. Also, a single power line 28 is illustrated as being coupled to each of the three (or more) elements.

In FIG. 2, each red, green, and blue OLED is generally rectangularly shaped with the long dimension being oriented horizontally so that the overall pixel is substantially square. Further, each column of pixels has a single data line associated with it and three scan lines. However, it will be understood that the orientation of either the data and scan lines and/or the pixels could be rotated ninety degrees if desired, as long as three scan lines and one data line are coupled to each pixel. The arrangement in FIG. 2 can be extended to displays incorporating full-color pixels beyond three color primaries, such as: red, green, blue and white, and/or yellow, sky-blue; red, green, blue, cyan, magenta, yellow and white; and so on.

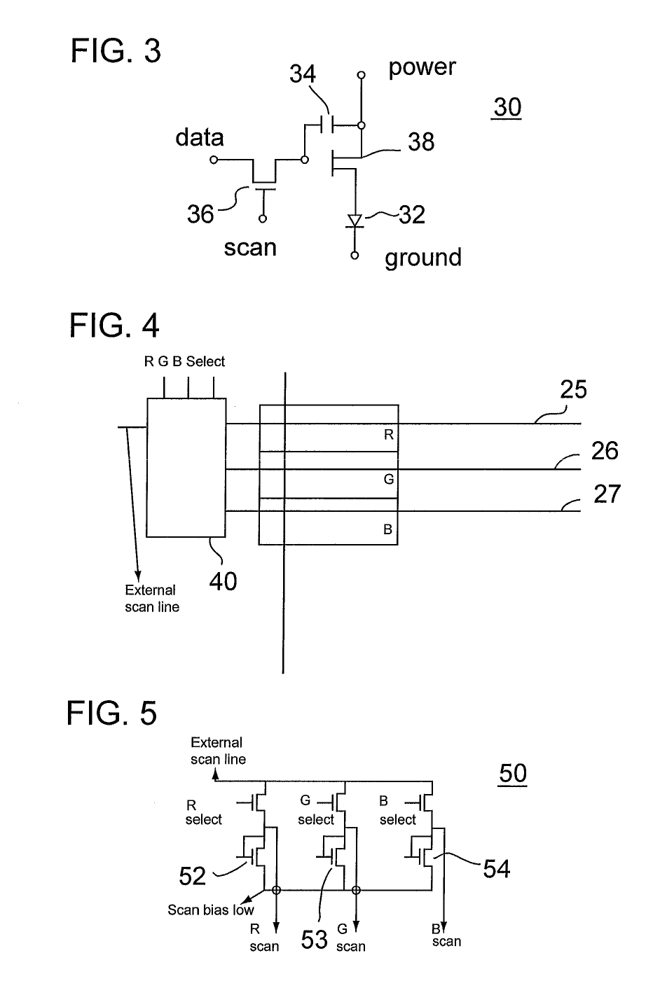

Referring additionally to FIG. 3, a typical active matrix circuit 30 for each element of each pixel is illustrated. As understood by those skilled in the art, the plurality of active circuits 30 coupled to the plurality of light emitting devices are fabricated in a backplane such as described in a copending U.S. patent application entitled “Mask Level Reduction for MOSFET”, filed 4 Nov. 2009, bearing Ser. No. 12/612,123, and incorporated herein by reference. The single element includes an OLED 32, a storage capacitor 34 and (in this example) a thin film transistor (TFT) controller 36 and a TFT driver 38. TFT controller 36 is activated by a scan line (e.g. scan line 25) connected to the gate and a data line (e.g. data line 29) is connected to the source/drain (S/D) terminals. As understood in the art, the scan line is generally implemented with the gate metal. The data line is generally implemented with the source/drain metal. The power line is best implemented with the source/drain metal without vias. While other variations of an active matrix OLED circuit may be available, all variations generally require separate scan lines and data lines and interconnecting transistors and a transparent conductor. Further, it is understood that storage capacitor 34 acts to store data between scans so that changes in the rate at which data is applied to a pixel or to an element will have no effect on the final display.

While the data line and power line of each pixel is positioned to extend across the pixel face in a spaced apart, parallel orientation there is a large enough space between the lines so as not to unduly affect the fill factor. Also, to improve the fill factor elements 22, 23, and 24 are oriented with the long dimension extending horizontally in FIG. 2, thus increasing the spacing between the parallel lines. The major advantage achieved with this format is the reduction in the number of the more expensive data drivers that are required.

Since the number of scan lines is increased by a factor of x (where x is the number of elements in each pixel), the speed required or time allotted for each scan line is also changed by a factor of x. Also, m can be greater than n (horizontal dimension greater) or n can be greater than m (vertical dimension greater) if desired. However, by using either MOTFTs (preferably) or poly-Si TFTs the change in speed or time can be easily achieved.

A single data driver can be used to drive all three pixel elements by simply sequencing the red, green, and blue data through a single driver as the scan signals are sequenced into the three elements of each pixel. Thus, when scan line 25 is activated by a scan signal the single data driver is activated with red data, when scan line 26 is activated by a scan signal the single data driver is activated with green data, and when scan line 27 is activated by a scan signal the single data driver is activated with blue data. This can be a simple sequencing circuit that is interconnected with all m data drivers and synchronized with the scan signals. Since the relatively complicated and expensive data drivers are generally located external to the backplane the additional sequencing circuit is relatively simple and inexpensive to incorporate.

It will be understood that similar pixel arrangement and operation principles can be used for advanced displays including full-color pixels beyond the red, green, and blue three color primaries. Full-color pixels with an improved color gamut, or with improved display efficiency can be achieved with 4-7 sub-pixels or pixel elements arranged in red, green, blue, white, and/or yellow, sky-blue or red, green, blue, cyan magenta, yellow, and/or white, and so on.

Referring to FIG. 4, the group of three (or x) scan lines for a single pixel can be coupled to a demux circuit 40. Demux circuit 40 can be a relatively simple switching circuit that utilizes a single input scan line and sequentially produces three or a group of scan signals in response. Referring additionally to FIG. 5, a demux circuit 50 that can be used as demux circuit 40 in FIG. 4 is illustrated. In circuit 50 three combination circuits of controller TFTs, R-select, G-select, and B-select, are illustrated. The gates of the three controller TFTs are coupled to a simple three signal generator that can be coupled to all demux circuits. The source/drain circuit of each of the three controller TFTs connect the single incoming scan signal to one of three load TFTs 52, 53, and 54 which in turn couple the scan signal to one of the three scan lines (R scan, G scan, and B scan) associated with a single pixel. In this embodiment, the controller TFTs and the load TFTs are preferably MOTFTs but could be poly-Si TFTs, or TFTs made with organic or organo-metallic compound semiconductors.

For example, while the scan signal is applied to the input of demux circuit 50, an R-select signal is applied to the R-select controller which in turn supplies the scan signal through load TFT 52 to scan line 25. While the scan signal is still being applied to the input of demux circuit 40, a G-select signal is applied to the G-select controller, after the R-select signal is removed from the R-select controller, which in turn supplies the scan signal through load TFT 53 to scan line 26. While the scan signal is still applied to the input of demux circuit 40, a B-select signal is applied to the B-select controller, after the g-select signal is removed from the g-select controller, which in turn supplies the scan signal through load TFT 54 to scan line 27. It will be understood that demux circuit 40 can be relatively easily fabricated on the backplane by, for example, a single circuit that cycles through three steps for each scan step coupled to the n demux circuits on the backplane. Thus, the number of scan lines actually coupled to the backplane will remain the same as prior formats. It will be understood that this demux circuit and driving scheme can be expanded to advanced displays with full-color sub-pixels beyond red, green, and blue sub-pixels. Demux circuits of 4-8 sub-scan lines can be designed following the same principle shown in FIGS. 4 and 5.

Thus, a new and improved active matrix that is relatively simple and less expensive to manufacture has been disclosed. The number of expensive scan drivers has been reduced by a factor of three so that the overall expense of the backplane is reduced.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. An active matrix incorporated in a color display device comprising:
an array of pixels arranged in n rows and m columns, each pixel including a plurality x of elements representing different color primaries;
a plurality of m data lines, a different one of the plurality of m data lines being coupled one each to each column of pixels and to each element of the plurality x of elements of each pixel in the column of pixels; and
a plurality n of groups of x scan lines, a different group of the plurality n of groups of x scan lines coupled to each of the n rows of pixels and each of the different x scan lines in each group coupled to a different one of the plurality x of elements, so that a single scan line of each group of the plurality n of groups of x scan lines is coupled to each element of each pixel.

2. An active matrix as claimed in claim 1 wherein the x elements of each pixel in the array are approximately equal in area, each element having a generally rectangular configuration with a horizontal length greater than the vertical width, the elements being arranged in a side-by-side orientation vertically.

3. An active matrix as claimed in claim 2 wherein the x elements of each pixel in the array include red, green, and blue elements.

4. An active matrix as claimed in claim 2 further including a plurality m of power lines one each coupled to each column of pixels and to each pixel in the column.

5. An active matrix as claimed in claim 4 wherein a power line of the plurality m of power lines and a data line of the plurality m of data lines coupled to each pixel are spaced apart on each pixel and positioned adjacent edges of the pixel.

6. An active matrix as claimed in claim 1 further including demux circuitry associated with the plurality of xn scan lines and designed to sequentially apply a single input scan signal to each of the x scan lines coupled to a pixel.

7. An active matrix as claimed in claim 1 wherein the plurality of x scan lines is each coupled to a scan driver designed to sequentially activate the scan lines one at a time.

8. An active matrix as claimed in claim 7 wherein active elements in the scan driver include one of MOTFTs, poly-Si TFTs, and TFTs with an active layer including organic or organo-metallic semiconductor material.

9. An active matrix as claimed in claim 1 wherein each element of each pixel in the array of pixels includes active elements in a backplane, the active elements including one of MOTFTs, poly-Si TFTs, and TFTs with an active layer including organic or organo-metallic semiconductor material.

10. An active matrix as claimed in claim 1 wherein each element of each pixel in the array of pixels includes one of an OLED and an LCD.

11. An active matrix incorporated in a color display device comprising:
an array of pixels arranged in n rows and m columns, each pixel having x elements including at least a red, a green, and a blue element;
a backplane including a plurality of active circuits, one each active circuit of the plurality of active circuits associated with each element of each pixel in the array of pixels and each active circuit of the plurality of active circuits electrically coupled to the associated element of each pixel of the array of pixels whereby the plurality of active circuits are arranged in an array of xn rows and m columns, each active circuit of the plurality of active circuits including MOTFT devices;
a plurality of m data lines, one each associated with each column of pixels in the array of pixels, each data line being electrically coupled to each active circuit in the associated column of pixels; and
a plurality n of groups each group including x scan lines, a different group of the plurality n of groups coupled to each of the n rows of pixels and each of the different x scan lines in each of the n groups coupled to a different one of the x elements.

12. An active matrix as claimed in claim 11 wherein the x elements of each pixel in the array are approximately equal in area, each element having a generally rectangular configuration with a horizontal length greater than the vertical width, the elements being arranged in a side-by-side orientation vertically.

13. An active matrix as claimed in claim 11 further including a plurality m of power lines one each associated with each column of pixels and coupled to each of the x elements of each pixel in the associated column.

14. An active matrix as claimed in claim 13 wherein a power line of the plurality m of power lines and a data line of the plurality m of data lines coupled to each pixel are spaced apart on each pixel and positioned adjacent edges of the pixel.

15. An active matrix as claimed in claim 11 wherein the x elements of each pixel in the array are approximately equal in area, and each element with a generally rectangular configuration having a vertical length greater than the horizontal width.

16. An active matrix as claimed in claim 11 further including a plurality of demux circuits one each associated with each row of pixels of the array of pixels, the plurality of demux circuits having n input scan signals, each demux circuit being designed to receive a different single input scan signal of the n input scan signals and sequentially apply the received single input scan signal to each of the x scan lines coupled to pixels in the associated row of pixels.

17. An active matrix as claimed in claim 11 wherein the plurality of xn scan lines is each coupled to a scan driver designed to sequentially activate the scan lines one at a time.

18. A method of operating an active matrix incorporated in a color display device comprising the steps of:
providing an array of pixels arranged in n rows and m columns, each pixel having x elements including at least a red, a green, and a blue element, a plurality of m data lines, one each coupled to each column of pixels and to each element of each pixel in the column, and a plurality of xn scan lines, a different group of the xn scan lines coupled to each of the n rows of pixels and each of the different groups coupled to a different one of the x elements;
activating the xn scan lines once for each frame one scan line at a time so as to activate the elements in the array of pixels one element per pixel at a time; and
activating the m data lines in a sequence to supply at least red, green and blue data in synch with the xn scan lines so as to supply red data to the red elements, green data to the green elements, and blue data to the blue elements as each of the red, green, and blue elements is activated by the scan lines.

19. A method as claimed in claim 18 including the steps of sequentially supplying n input scan signals and multiplexing the n input scan signals to provide n groups of x scan signals, one of the n groups for each of the n input scan signals, coupling one each of the n groups to an associated row of pixels in the n rows of pixels, and sequentially applying each signal in each of the n groups to a different element of the pixels in the associated row of pixels.

20. A method as claimed in claim 19 including the step of providing a plurality of demux circuits, one for each group of the n groups, and each demux circuit including one of MOTFTs, poly-Si TFTs, and TFTs with an active layer including organic or organo-metallic semiconductor material.

21. A method as claimed in claim 18 including the step of providing a plurality of active circuits, one each for each element of each pixel in the array of pixels, and each active circuit including one of MOTFTs, poly-Si TFTs, and TFTs with an active layer including organic or organo-metallic semiconductor material.
